(19) United States
(12) Patent Application Publication
(10) Pub. No.: US 2021/0060717 A1
(43) Pub. Date: Mar. 4, 2021

(54) RIVETING AND GRINDING ASSEMBLY FOR THER NOZZLE OF A SCREW SHAFT VALVE

(71) Applicant: Dongguan University of Technology, Dongguan (CN)

(72) Inventors: Jun Deng, Dongguan (CN); Chuliang He, DONGGUAN (CN)

(21) Appl. No.: 16/559,301

(22) Filed: Sep. 3, 2019

(51) Int. Cl. B23P 23/04; B23Q 1/26; B23Q 3/06

(52) U.S. Cl. CPC B23P 23/04; F16C 2322/39; B23Q 3/064; B23Q 1/26

(57) ABSTRACT

The present invention generally relates to assembly equipment of valve body, especially to riveting and grinding assembly for nozzle of screw shaft valve. The invention may include a rack, a power control box, a turntable and a turntable divider. A carrier assembly which engages with the screw shaft valve body is installed on the edge of the turntable with uniform distribution. On the center part of the turntable, a support shaft which is installed on and fixed with the rack is vertically interposed and on the top of the support shaft, an upper supporting disc is installed. A valve pipe feeding device, a valve pipe preloading device, a valve pipe riveting device and a valve pipe grinding device which engage with the carrier assembly are installed on the said rack on the rotational direction of turntable. As the threaded pipe is put into the carrier assembly by valve pipe feeding device, the carrier assembly rotates counterclockwise along the turntable and rotates to the valve pipe feeding device to the press threaded pipe into the valve seat. Thereafter the carrier assembly rotates the valve pipe riveting device and rivets threaded pipe with a valve flange in order to finish assembling process. Finally, the carrier assembly rotates the valve pipe grinding device to grind nozzle of valve to finish grinding and riveting process of threaded pipe with high positioning accuracy of assembly and marvelous hermetic sealing.

### FIELD OF THE INVENTION

The present invention relates generally to assembly equipment for valve bodies, and more especially to a riveting and grinding assembly for the nozzle of a screw shaft valve.

### BACKGROUND OF THE INVENTION

Screw shaft valve 17, as shown in FIG. 13, may include a valve seat 22 whose lower part is connected to a lower valve tube 24. To the side of the valve seat 22, a r-type side valve pipe is connected. And on its upper end, a valve flange 20 which rivets the threaded pipe 21 on the upper end is connected 20. To the side of the valve flange 20, a side positioning plate 23 is installed. Existing technology requires an operator to assemble Tee shaped screw shaft valve by hand which is not efficient and accurate enough and the hermetic sealing is not satisfactory. Acceptance rate and production efficiency are influenced. In addition, as threaded pipe directly rivets valve flange, burrs from nozzle of screw shaft valve will exist, which will further influence the hermetic sealing of the product.

### SUMMARY OF THE INVENTION

The present invention relates to a riveting and grinding assembly for the nozzle of a screw shaft valve. First, put threaded pipe into a carrier assembly by a loading device. Then the carrier assembly rotates counterclockwise and rotates to a prevalve pipe feeding device to press the threaded pipe into a valve seat. Next a valve pipe riveting device rivets the threaded pipe with a valve flange in order to finish assembling process. Then the carrier assembly rotates to a valve pipe grinding device to grind nozzle of valve to finish grinding and riveting process of threaded pipe with high positioning accuracy of assembly and marvelous hermetic sealing.

To accomplish the above goal, the present technical schemes of invention relates to a riveting and grinding assembly for nozzle of screw shaft valve, which may include a rack 1, a power control box, a turntable 2 and a turntable divider which engage with each other and are installed on the rack 1. On the edge of the said turntable 2, several carrier assemblies 3 which engage with the screw shaft valve body 17 are distributed in even span. On the center part of the said turntable 2, a support shaft 9 which is fixed with the rack 1 is vertically interposed and on top of the support shaft 9, an upper supporting disc 10 is installed. On the said rack 1, a valve pipe feeding device 4, a valve pipe preloading device 6, a valve pipe riveting device 7 and a valve pipe grinding device 8 which engage with the carrier assembly 3 are installed in the rotational direction of the turntable 2. The said turntable divider, valve pipe feeding device 4, valve pipe preloading device 6, valve pipe riveting device 7 and valve pipe grinding device 8 are all electrically connected to the power control box.

Preferably, the said valve pipe grinding device 8 may include a grinding rack 54 which is installed on the rack 1 and a carrier support 25 which is installed under the turntable 2 and engages with the carrier assembly 3. On horizontal direction of the grinding rack 54, a transverse grinding knife raising plate 57 which engages with the upper supporting disc 10 is installed. On the upper end of the said grinding rack 54, a push-in grinding cylinder 55 and a grinding knife adjusting cylinder 56 are installed with topside down in vertical direction. The output side of the said grinding knife adjusting cylinder 56 goes through the transverse grinding knife raising plate 57 and is connected to a grinding knife raising plate 58. On the said grinding knife raising plate 58, a grinding knife 62 which engages with the threaded pipe 21 by means of plug and fit is installed vertically. The output end of the said push-in grinding cylinder 55 is connected to a grinding spindle 61 which engages with the upper end of the grinding knife 62. Both the said push-in grinding cylinder 55 and grinding knife adjusting cylinder 56 are electrically connected to the power control box.

Preferably, a stopper cylinder 59 is installed on the bottom of the said transverse grinding knife raising plate 57. At the output end of the said stopper cylinder 59 a holding plate 60 which engages the screw shaft valve body 17 is connected. On one end of the said holding plate 60 is set an open slot designed for the threaded pipe 21. The said stopper cylinder 59 is electrically connected to the power control box.

Preferably, the said carrier assembly 3 may include a carrier seat 12 which is installed on the turntable 2 by fixing bolts 11. On center part of the said carrier seat 12 is set a countersunk hole where a hollow carrier positioning axis 14 is installed by plugging and fitting. On the said carrier positioning axis 14, a carrier cover plate 13 which engages with the carrier seat 12 is fixed. Between the said carrier positioning axe 14 and the said carrier seat 12, a carrier damping spring 18 is installed. On upper end of the said positioning axis 14, a loading seat 15 which engages with the valve seat 22 by plug and fit is sleeved. On both sides of the said loading seat 15, positioning slots 16 which respectively engage with the side positioning plate 23 and the side valve pipe 19 are installed.

Preferably, the said valve pipe feeding device 4 may include a loading rack 26 installed on the rack 1, a vibration feeding pan 5, and a carrier support 25 which engages with the carrier assembly 3 and is installed under the turntable 2. On the said feeding rack 26, a transverse feeding plate 34 which is connected to the upper supporting disc 10 is horizontally installed. On the said transverse feeding plate 34, a threaded pipe distribution device which engages with the vibration feeding pan 5 is installed. On upper end of the said feeding rack 26, a feeding cylinder 29 is installed vertically downward. On the output end of the said feeding cylinder 29 is connected a push-in lever 27 which shares the same axis with the carrier positioning axe 14. The lower end of the said push-in lever 27 goes through a push-in guide plate 28 which is installed on the transverse feeding plate 34, and the push-in lever 27 engages with threaded pipe distribution device by means of plug and fit. The said feeding cylinder 29 and the vibration feeding pan 5 are electrically connected to the power control box.

Preferably, the said threaded pipe distribution device may include a dispensing base 32 which is installed on the transverse feeding plate 34 on horizontal direction. On one end of the said dispensing base 32 is embedded a guiding sliding sleeve 36 which shares the same axis with the push-in lever 27. In the said guiding sliding sleeve 36 is slidably set a push-in joining pipe 37 engaging with the push-in lever 27 by means of plug and fit. On the lower end of the said push-in joining pipe 37, a guiding connecting plate 38 is sleeved. The said guiding connecting plate 38 is connected to the output of joining guide cylinder 33 which is installed on the transverse feeding plate 34 vertically. On the other end of the said distribution seat 32, a pushing cylinder 31 is installed on the horizontal direction. On the output end of the said pushing cylinder 31 is connected a distribution displacement block 35 which slidably engages with the distribution seat 32. On top of the said distribution displacement block 35, a dispensing seat 39 is installed and on the upper end of the said dispensing seat 39 is sleeved a guide tube 30 which engages with the vibration feeding pan 5 by means of plug and fit. The lower end of the said guide tube 30 may communicate with a dispensing hole in the distribution displacement block 35, and lower end of the same dispensing hole may communicate with the push-in joining pipe 37. The said pushing cylinder 31 and joining guide cylinder 33 are electrically connected to the power control box.

Preferably, said valve pipe preloading device 6 may include a push-in rack which is installed on the rack 1 and a carrier support 25 which is installed under the turntable 2 and engages with the carrier assembly 3. On the said push-in rack 40, a transverse push-in plate 45 which is connected to the upper supporting disc 10 is installed on horizontal direction. On the transverse push-in plate 45, directly above the carrier assembly a push-in guide bearing 44 is installed by plug and fit. On top of the push-in support 40, a valve pipe push-in cylinder 41 is vertically installed downwards. The output end of the said valve pipe push-in cylinder 41 is connected with a push-in shaft 42, which engages with the push-in guiding bearing 44 by plug and fit, furthermore, the push-in shaft and the thread valve pipe on the carrier assembly 3 shares the same axe. A push-in buffer spring 43 is sleeved to the push-in shaft 42. The said valve pipe push-in cylinder 41 is electrically connected to the power control box.

Preferably, said valve pipe riveting device 7 may include a riveting rack 46 which is installed on the rack 1 and a carrier support 25 which is installed under the turntable 2 and engages with the carrier assembly 3. On the said riveting rack 46, a transverse riveting plate 48 which is connected to the upper supporting disc 10 is installed horizontally. Immediately above the carrier assembly 3 on the said transverse riveting plate 48 is set a riveting guide bearing 47 by means of plug and fit. On top of the said riveting rack 46, a riveting cylinder 51 whose output is connected to a riveting spindle 50 is installed vertically downward. On the lower end of the said riveting spindle 50 is set a hole which engages with the threaded pipe 21 by means of plug and fit and inside the hole, there is a guide plug 53 engaging with the threaded pipe 21 by sliding. An inner riveting damper spring 52 is installed at the connection between the upper end of the said guide plug 53 and the riveting spindle 50 while an outer riveting damper spring 49 engaging with the upper end of the riveting guiding bearing 47 is set on the riveting spindle 50. The said riveting cylinder 51 is electrically connected to the power control box.

Preferably, on the front left of the said turntable 2, an unloading device is installed, which may include an unloading rack 63 which is installed on the rack 1. And on top of the said unloading rack 63, a transverse unloading plate 64 is installed vertically. On the said transverse unloading plate 64, an unloading translational sliding bar 65 is installed vertically. A pneumatic sliding block 66 is slidably fixed on the said unloading translational sliding bar 65. On the said pneumatic sliding block 66, a reclaiming and discharging cylinder 67 is vertically fixed. The output of the said reclaiming and discharging cylinder 67 is connected to a clamping cylinder 68 whose lower end is connected a clamping claw 69 which engages with the screw shaft valve body 17. A clamping opening 70 engaging with the threaded pipe 21 is installed on the said clamping claw 69.

### BRIEF DESCRIPTION OF THE DRAWINGS

FIG. 1 shows a stereoscopic view of a structure of the invention;

FIG. 2 shows a stereoscopic view of a structure of grinding device of nozzle;

FIG. 3 shows a stereoscopic view of a partially enlarged view of part D;

FIG. 4 shows a stereoscopic view of a turntable;

FIG. 5 shows a stereoscopic view of a carrier assembly;

FIG. 6 is a sectional view taken along line A-A in FIG. 5;

FIG. 7 shows a stereoscopic view of a valve pipe feeding device;

FIG. 8 shows a stereoscopic view of the structure of a distribution device of threaded pipe;

FIG. 9 shows a stereoscopic view of the structure of a push-in device;

FIG. 10 shows a stereoscopic view of the structure of a riveting pipe-valve;

FIG. 11 is a sectional view taken along line A-A in FIG. 10;

FIG. 12 shows a stereoscopic view of a partially enlarged view of part D in FIG. 11;

FIG. 13 shows a stereoscopic view of a screw shaft valve;

FIG. 14 shows a stereoscopic view of a feeding device; and

FIG. 15 shows a stereoscopic view of a clamping claw.

### DETAILED DESCRIPTION OF THE ILLUSTRATED EMBODIMENT

Component parts in the FIGURES are:
1. rack,
2. turntable,
3. carrier assembly,
4. valve pipe feeding device,
5. vibration feeding pan,
6. valve pipe preloading device,
7. valve pipe riveting device,
8. valve pipe grinding device,
9. support shaft,
10. upper supporting disc
11. fixing bolt,
12. carrier seat,
13. carrier cover plate,
14. carrier positioning axis,
15. loading seat,
16. positioning slot,
17. screw shaft valve body,
18. carrier damping spring,
19. side valve pipe,
20. valve flange,
21. threaded pipe,
22. valve seat,
23. side positioning plate,
24. lower valve tube
25. carrier support,
26. loading rack,
27. push-in lever,
28. push-in guide plate,
29, feed cylinder
30. guide tube,
31. pushing cylinder,
32. dispensing base,
33. joining guide cylinder,
34. transverse feeding plate,
35. distribution displacement block,
36. guiding sliding sleeves,
37. push-in joining pipe,
38. guiding connecting plate,
39. dispensing seat,
40. push-in rack,
41. valve pipe push-in cylinder,
42. push-in axis,
43. push-in damper spring,
44. push-in guide bearings,
45. transverse push-in plate,
46. riveting rack,
47. riveting guide bearings,
48. transverse riveting plate,
49. outer riveting damper spring,
50. riveting spindle,
51. riveting cylinder,
52. inner riveting damper spring,
53, guide plug,
54. grinding rack.
55, push-in grinding cylinder,
56. grinding knife adjusting cylinder,
57. transverse grinding knife raising plate.
58. grinding knife raising plate,
59. stopper cylinder,
60. holding plate,
61. grinding spindle,
62. grinding,
63. feeding rack,
64. transverse unloading plate,
65. unloading translational sliding bar,
66. pneumatic sliding block,
67. reclaiming and discharging cylinder,
68. clamping cylinder,
69. clamping claws,
70. clamping opening.

The aforenoted and other features and advantages of the invention will be more fully understood from the following detailed description of certain embodiments of the invention, taken together with the accompanying drawings, which are meant to illustrate and not to limit the invention.

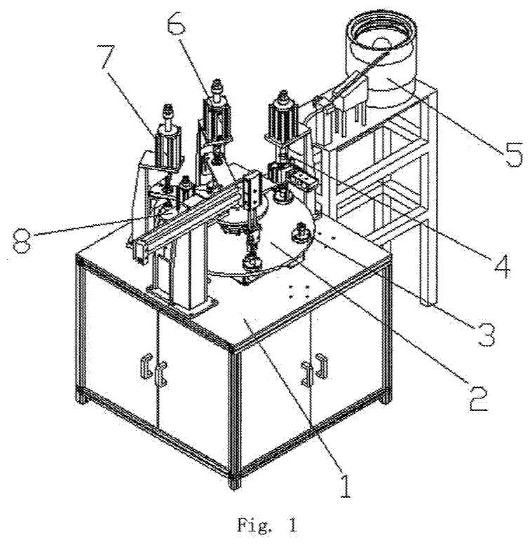

As is shown in FIG. 1, the riveting and grinding assembly for nozzle of screw shaft valve may include a rack 1, a power control box, a turntable 2 and a turntable divider which engage with each other and are installed on the rack 1. On the edge of the said turntable 2, several carrier assemblies 3 which engage with the screw shaft valve body 17 are distributed in even span. On the center part of the said turntable 2, a support shaft 9 which is fixed with the rack 1 is vertically interposed and on top of the support shaft 9, an upper supporting disc 10 is installed. On the said rack 1, a valve pipe feeding device 4, a valve pipe preloading device 6, a valve pipe riveting device 7 and a valve pipe grinding device 8 which engage with the carrier assembly 3 are installed in the rotational direction of the turntable 2. The said turntable divider, valve pipe feeding device 4, valve pipe preloading device 6, valve pipe riveting device 7 and valve pipe grinding device 8 are all electrically connected to the power control box. As threaded pipe 21 is put into the carrier assembly 3 by valve pipe feeding device 4, carrier assembly 3 rotates in counterclockwise along the turntable 2 and rotates to the valve pipe preloading device 6 to press threaded pipe 21 into valve seat 22. Next rotates to the valve pipe riveting device 7 rivets threaded pipe 21 with valve flange 20 in order to finish assembling process. Then the carrier assembly 3 rotates to valve pipe grinding device 8 to grind nozzle of valve to finish grinding and riveting process of threaded pipe 21 with high positioning accuracy of assembly and marvelous hermetic sealing.

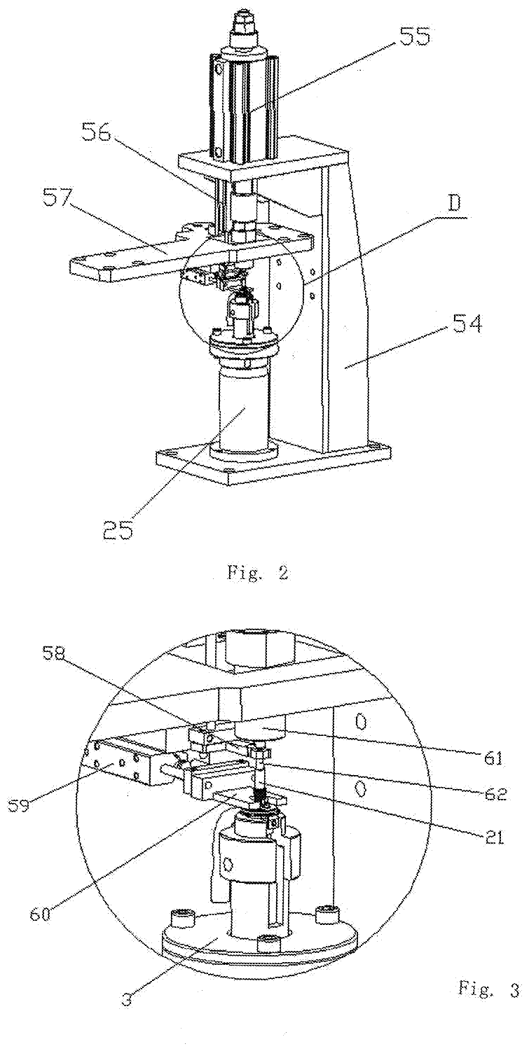

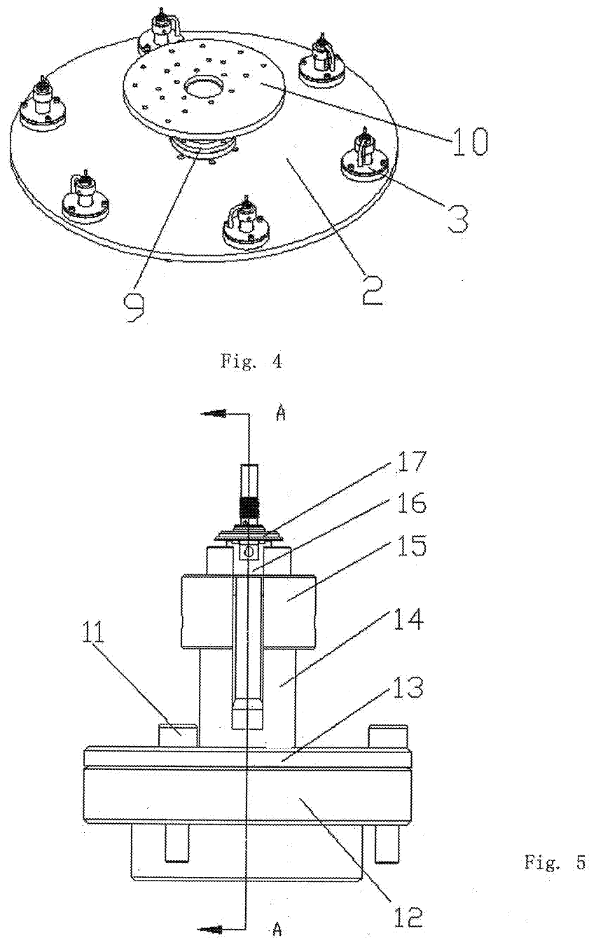

As is shown in FIGS. 2-3, the said valve pipe grinding device 8 may include a grinding rack 54 which is installed on the rack 1 and a carrier support 25 which is installed under the turntable 2 and engages with the carrier assembly 3. On horizontal direction of the grinding rack 54, a transverse grinding knife raising plate 57 which engages with the upper supporting disc 10 is installed. On the upper end of the said grinding rack 54, a push-in grinding cylinder 55 and a grinding knife adjusting cylinder 56 are installed with topside down in vertical direction. The output side of the said grinding knife adjusting cylinder 56 goes through the transverse grinding knife raising plate 57 and is connected to a grinding knife raising plate 58. On the said grinding knife raising plate 58, a grinding knife 62 which engages with the threaded pipe 21 by means of plug and fit is installed vertically. The output end of the said push-in grinding cylinder 55 is connected to a grinding spindle 61 which engages with the upper end of the grinding knife 62. Both the said push-in grinding cylinder 55 and grinding knife adjusting cylinder 56 are electrically connected to the power control box. With the push-in grinding cylinder 55 push the grinding spindle 61 downwardly, drive the grind 62 to insert threaded pipe 21 to squeeze and grind, it's convenient to get rid of burring.

As is shown in FIG. 3, a stopper cylinder 59 is installed on the bottom of the said transverse grinding knife raising plate 57. At the output end of the said stopper cylinder 59 a holding plate 60 which engages the screw shaft valve body 17 is connected. On one end of the said holding plate 60 is set an open slot designed for the threaded pipe 21. The said stopper cylinder 59 is electrically connected to the power control box, driving the holding plate 60 forward by stopper cylinder 59 to make it cover the screw shaft valve body, which may prevent the screw shaft valve body to be taken out of the carrier assembly 3 when the grinding 62 is extracted from threaded pipe 21.

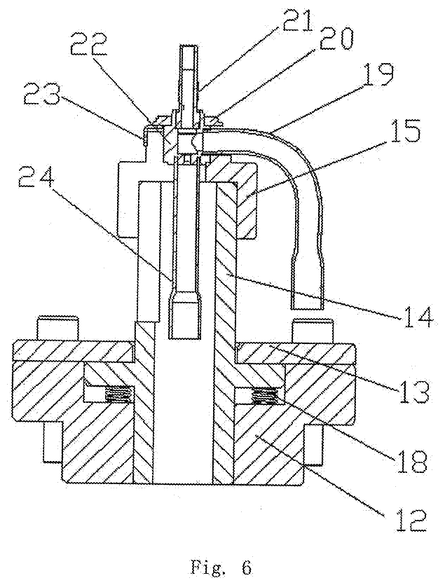

As is shown in FIGS. 5-6, the said carrier assembly 3 may include a carrier seat 12 which is installed on the turntable 2 by fixing bolts 11. On center part of the said carrier seat 12 is set a countersunk hole where a hollow carrier positioning axis 14 is installed by plugging and fitting. On the said carrier positioning axis 14, a carrier cover plate 13 which engages with the carrier seat 12 is fixed. Between the said carrier positioning axe 14 and the said carrier seat 12, a carrier damping spring 18 is installed. On upper end of the said positioning axis 14, a loading seat 15 which engages with the valve seat 22 by plug and fit is sleeved. On both sides of the said loading seat 15, positioning slots 16 which respectively engage with the side positioning plate 23 and the side valve pipe 19 are installed. With carrier positioning axis 14 locating the valve seat 22, positioning slots 16 contains the side valve pipe 19 and the side positioning plate 23, the screw shaft valve body 17 may not turn during assembly process to ensure assembly precise.

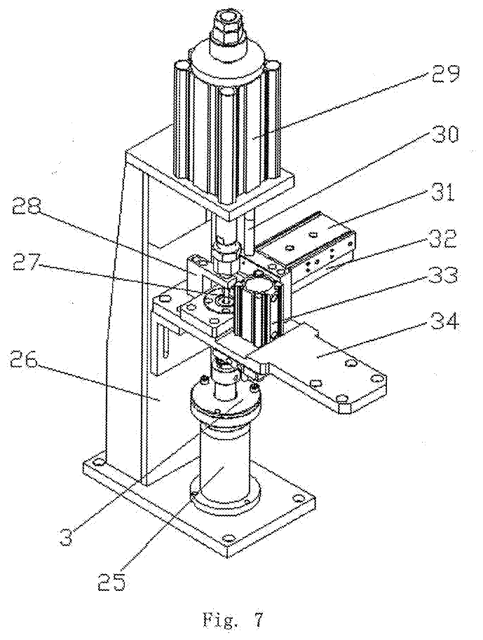

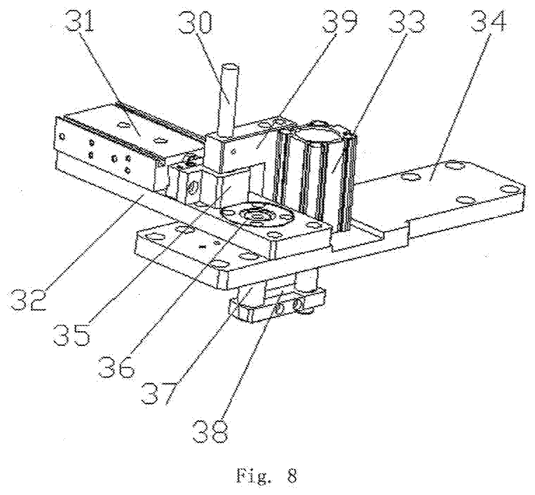

As is shown in FIG. 7, the said valve pipe feeding device 4 may include a loading rack 26 installed on the rack 1, a vibration feeding pan 5, and a carrier support 25 which engages with the carrier assembly 3 and is installed under the turntable 2. On the said feeding rack 26, a transverse feeding plate 34 which is connected to the upper supporting disc 10 is horizontally installed. On the said transverse feeding plate 34, a threaded pipe distribution device which engages with the vibration feeding pan 5 is installed. On upper end of the said feeding rack 26, a feeding cylinder 29 is installed vertically downward. On the output end of the said feeding cylinder 29 is connected a push-in lever 27 which shares the same axis with the carrier positioning axe 14. The lower end of the said push-in lever 27 goes through a push-in guide plate 28 which is installed on the transverse feeding plate 34, and the push-in lever 27 engages with threaded pipe distribution device by means of plug and fit. The said feeding cylinder 29 and the vibration feeding pan 5 are electrically connected to the power control box. A Screw shaft valve body 17 is transported to the distributing device of threaded pipe by vibration feeding pan 5. The push-in lever 27 is pushed downwardly by feeding cylinder 29 to make push-in lever 27 go through the push-in guide plate 28 and the distributing device of threaded pipe, and then put threaded pipe 21 which is in the distributing device of threaded pipe into the carrier assembly 3 to finish feeding process.

As is shown in FIG. 8, the said threaded pipe distribution device 34 may include a dispensing base 32 which is installed on the transverse feeding plate 34 on horizontal direction. On one end of the said dispensing base 32 is embedded a guiding sliding sleeve 36 which shares the same axis with the push-in lever 27. In the said guiding sliding sleeve 36 is slidably set a push-in joining pipe 37 engaging with the push-in lever 27 by means of plug and fit. On the lower end of the said push-in joining pipe 37, a guiding connecting plate 38 is sleeved. The said guiding connecting plate 38 is connected to the output of joining guide cylinder 33 which is installed on the transverse feeding plate 34 vertically. On the other end of the said distribution seat 32, a pushing cylinder 31 is installed on the horizontal direction. On the output end of the said pushing cylinder 31 is connected a distribution displacement block 35 which slidably engages with the distribution seat 32. On top of the said distribution displacement block 35, a dispensing seat 39 is installed and on the upper end of the said dispensing seat 39 is sleeved a guide tube 30 which engages with the vibration feeding pan 5 by means of plug and fit. The lower end of the said guide tube 30 may communicate with a dispensing hole in the distribution displacement block 35, and lower end of the same dispensing hole may communicate with the push-in joining pipe 37. The said pushing cylinder 31 and joining guide cylinder 33 are electrically connected to the power control box. With threaded pipe 21 dropping into the distribution displacement block 35 through the guide tube 30, the pushing cylinder 31 drives the distribution displacement block 35 along dispensing base 32, to make distributing hole vertically aligned with the push-in joining pipe 37. And then threaded pipe drops into the push-in joining, pipe 37 and make the distribution displacement block 35 reset to make it vertically aligned with the dispensing seat 39. Then push the push-in joining pipe 37 by joining guide cylinder 33 to make it connected to the carrier assembly 3, at the same time, the feed cylinder 29 pushes push-in lever 27 downward and drives push-in lever 27 into push-in joining pipe 37 to make threaded pipe drop into the carrier assembly 3 to finish feeding process with positioning accuracy.

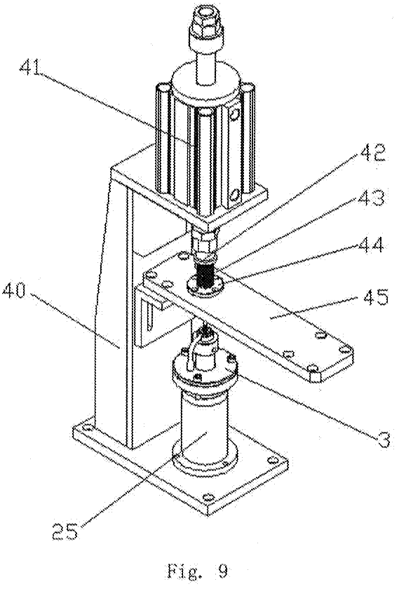

As is shown in FIG. 9, said valve pipe preloading device 6 may include a push-in rack which is installed on the rack 1 and a carrier support 25 which is installed under the turntable 2 and engages with the carrier assembly 3. On the said push-in rack 40, a transverse push-in plate 45 which is connected to the upper supporting disc 10 is installed on horizontal direction. On the transverse push-in plate 45, directly above the carrier assembly a push-in guide bearing 44 is installed by plug and fit. On top of the push-in support 40, a valve pipe push-in cylinder 41 is vertically installed downwards. The output end of the said valve pipe push-in cylinder 41 is connected with a push-in shaft 42, which engages with the push-in guiding bearing 44 by plug and fit, furthermore, the push-in shaft and the thread valve pipe on the carrier assembly 3 shares the same axe. A push-in buffer spring 43 is sleeved to the push-in shaft 42. The said valve pipe push-in cylinder 41 is electrically connected to the power control box. Pressing cylinder of pipe-valve is installed above. With valve pipe push-in cylinder 41 driving push-in axis 42, push-in axis 42 is connected to threaded pipe 21 which is pressed into valve seat 22 to finish pre-pressing-in process.

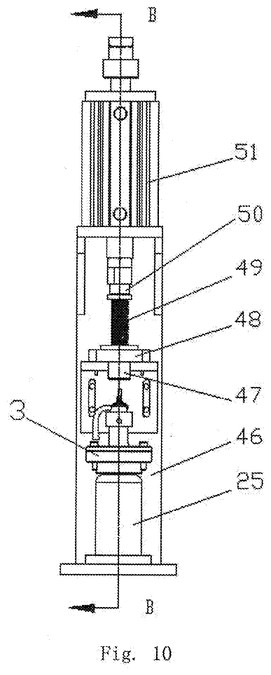

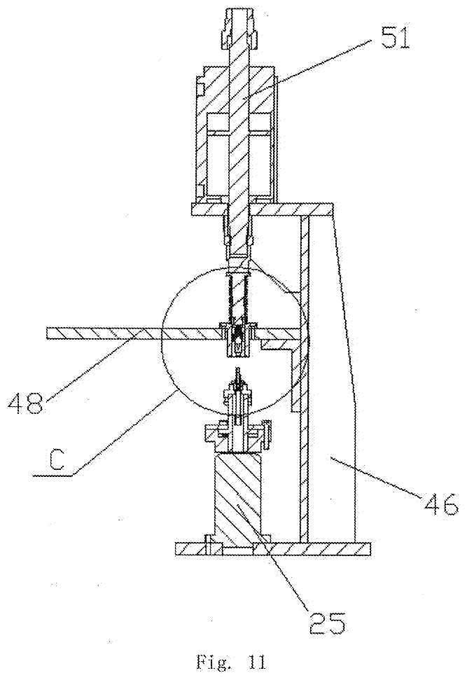

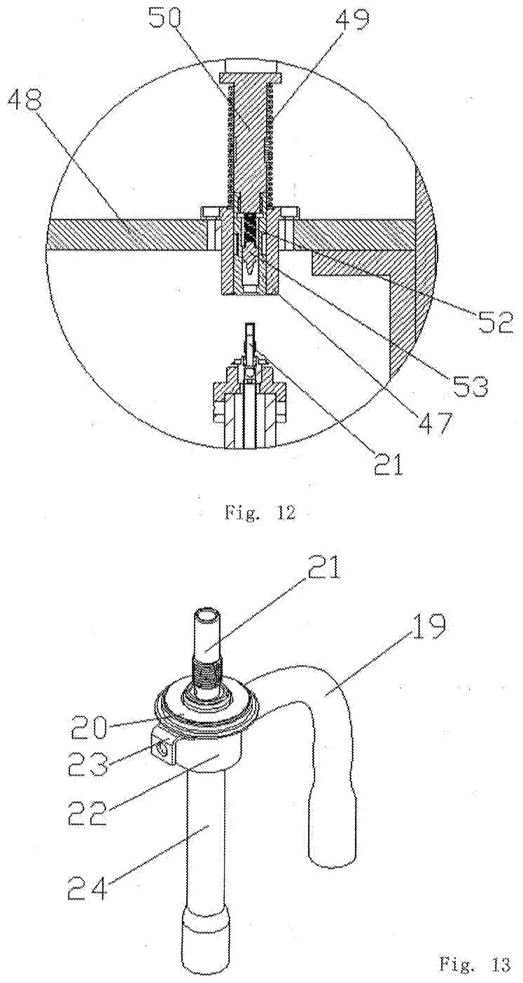

As is shown in FIGS. 10-12, the said valve pipe riveting device 7 may include a riveting rack 46 which is installed on the rack 1 and a carrier support 25 which is installed under the turntable 2 and engages with the carrier assembly 3. On the said riveting rack 46, a transverse riveting plate 48 which is connected to the upper supporting disc 10 is installed horizontally. Immediately above the carrier assembly 3 on the said transverse riveting plate 48 is set a riveting guide bearing 47 by means of plug and fit. On top of the said riveting rack 46, a riveting cylinder 51 whose output is connected to a riveting spindle 50 is installed vertically downward. On the lower end of the said riveting spindle 50 is set a hole which engages with the threaded pipe 21 by means of plug and fit and inside the hole, there is a guide plug 53 engaging with the threaded pipe 21 by sliding. An inner riveting damper spring 52 is installed at the connection between the upper end of the said guide plug 53 and the riveting spindle 50 while an outer riveting damper spring 49 engaging with the upper end of the riveting guiding bearing 47 is set on the riveting spindle 50. The said riveting cylinder 51 is electrically connected to the power control box. With driving the riveting spindle 50 downward by riveting axis 51, to make the guide plug 53 bears against the upper end of threaded pipe 21 and riveting cylinder 51 press down for some distances to make the lower end of the riveting spindle 50 connected to the valve flange 20 of carrier assembly 3 to finish riveting process.

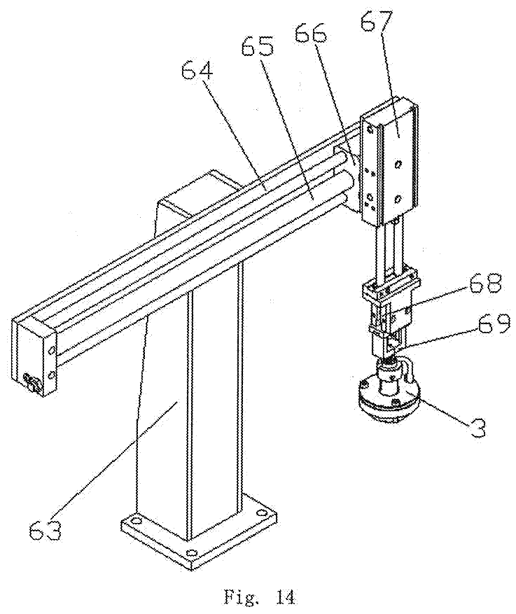

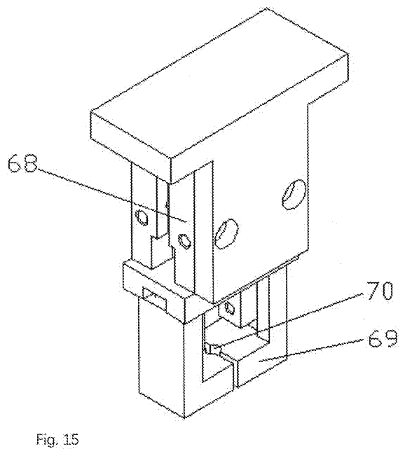

As is shown in FIGS. 14-15, on the front left of the said turntable 2, an unloading device is installed, which may include an unloading rack 63 which is installed on the rack 1. And on top of the said unloading rack 63, a transverse unloading plate 64 is installed vertically. On the said transverse unloading plate 64, an unloading translational sliding bar 65 is installed vertically. A pneumatic sliding block 66 is slidably fixed on the said unloading translational sliding bar 65. On the said pneumatic sliding block 66, a reclaiming and discharging cylinder 67 is vertically fixed. The output of the said reclaiming and discharging cylinder 67 is connected to a clamping cylinder 68 whose lower end is connected a clamping claw 69 which engages with the screw shaft valve body 17. A clamping opening 70 engaging with the threaded pipe 21 is installed on the said clamping claw 69. The screw shaft valve body 17 is clamped by clamping claws 69 which is driven by clamping cylinder 68, and clamping cylinder engages with threaded pipe 21 by clamping opening 70, and then pick up reclaiming and clamping cylinder 67, and the direction of unloading is along transverse unloading plate 64 by pneumatic sliding block 66.

In practical use, the screw shaft valve body is put into the carrier assembly 3 and the feeding process of threaded pipe 21 which is dropped into the distribution displacement block 35 by guide tube 30 may be proceed on the carrier assembly 3. Then the pushing cylinder 31 pushes the distribution displacement block 35 along dispensing base 32, to make the distributing hole vertically aligned with the push-in joining pipe 37. After the screw shaft valve body 17 is dropped into the push-in joining pipe 37, then the user may reset the distribution displacement block 35 and make it vertically aligned with the dispensing seat 39. Then feed cylinder 29 pushes the push-in lever 27 to make it insert into the push-in joining pipe 37 and make threaded pipe 21 drop into the carrier assembly 3 to finish feeding process with accurate location. The carrier assembly 3 rotates counterclockwise, turn to valve pipe preloading device 6 and drive threaded pipe into the pressing valve seat 22, then pushed the push-in axis 42 downward by valve pipe push-in cylinder 41 and makes it connected with threaded pipe 21 on the carrier assembly 3, to make it push into valve seat 22 to finish pre-pressing process. Then carrier assembly 3 proceeds rotation under the valve pipe riveting device 7, the riveting threaded pipe 21 and the valve flange 20, and push riveting spindle 50 downward by riveting cylinder 51, to make the lower end of riveting axis 50 connected to valve flange 20 which is on the carrier assembly 3 to finish the riveting process of wire rod pipe-valve with accurate location and good sealing. Then carrier assembly 3 continue to turn to the valve pipe grinding device 8 and grinding spindle 61 downward by push-in grinding cylinder 55, and then drive grinding 62 and insert it into the port of threaded pipe 21 to squeeze and grind with easy operation without burr. At the same time stopper cylinder 59 push holding plate 60 forward to make it cover the screw shaft valve body in case the screw shaft valve body is taken out of carrier assembly 3 when grinding 62 is extracted from threaded pipe 21

It should be noted that as the term “comprising” is used herein, “comprising” or any other variants thereof is intended to encompass a non-exclusive inclusion, such that a process comprising a series of elements is included, the method, the article or the device not only comprise those elements but also include other elements not explicitly listed, or further comprises the inherent elements of the process, the method, the article or the equipment.

The principles and the implementation mode of the invention are set forth in the specification, the description of the above examples is only used for helping understand the method of the invention and the core idea of the method, the above descriptions are only pthe said embodiments of the present invention, and it should be noted that, due to the limitation of character expression, an infinite specific structure exists objectively, for persons of ordinary skill in the art, without departing from the principle of the present invention, a plurality of improvements, modifications and changes can be made, and the technical features can also be combined in a proper manner; the conception and the technical scheme of the invention can be directly applied to other occasions without improving the conception and the technical scheme of the invention, should be regarded as the protection scope of the invention.

What is claimed is:

1. A riveting and grinding assembly for nozzles of screw shaft valve, which may include a rack (1), a power control box, a turntable (2) and a turntable divider which engage with each other and are installed on the rack (1). On the edge of the said turntable (2), several carrier assemblies (3) which engage with the screw shaft valve body (17) are distributed in even span. On the center part of the said turntable (2), a support shaft (9) which is fixed with the rack (1) is vertically interposed and on top of the support shaft (9), an upper supporting disc (10) is installed. On the said rack (1), a valve pipe feeding device (4), a valve pipe preloading device (6), a valve pipe riveting device (7) and a valve pipe grinding device (8) which engage with the carrier assembly (3) are installed in the rotational direction of the turntable (2). The said turntable divider, valve pipe feeding device (4), valve pipe preloading device (6), valve pipe riveting device (7) and valve pipe grinding device (8) are all electrically connected to the power control box.

2. A riveting and grinding assembly for nozzle of screw shaft valve in accordance with claim 1, wherein the said valve pipe grinding device (8) may include a grinding rack (54) which is installed on the rack (1) and a carrier support (25) which is installed under the turntable (2) and engages with the carrier assembly (3). On horizontal direction of the grinding rack (54), a transverse grinding knife raising plate (57) which engages with the upper supporting disc (10) is installed. On the upper end of the said grinding rack (54), a push-in grinding cylinder (55) and a grinding knife adjusting cylinder (56) are installed with topside down in vertical direction. The output side of the said grinding knife adjusting cylinder (56) goes through the transverse grinding knife raising plate (57) and is connected to a grinding knife raising plate (58). On the said grinding knife raising plate (58), a grinding knife (62) which engages with the threaded pipe (21) by means of plug and fit is installed vertically. The output end of the said push-in grinding cylinder (55) is connected to a grinding spindle (61) which engages with the upper end of the grinding knife (62). Both the said push-in grinding cylinder (55) and grinding knife adjusting cylinder (56) are electrically connected to the power control box.

3. A riveting and grinding assembly for nozzle of screw shaft valve in accordance with claim 2, wherein a stopper cylinder (59) is installed on the bottom of the said transverse grinding knife raising plate (57). At the output end of the said stopper cylinder (59) a holding plate (60) which engages the screw shaft valve body (17) is connected. On one end of the said holding plate (60) is set an open slot designed for the threaded pipe (21). The said stopper cylinder (59) is electrically connected to the power control box.

4. A riveting and grinding assembly for nozzle of screw shaft valve in accordance with claim 1, wherein the said carrier assembly (3) may include a carrier seat (12) which is installed on the turntable (2) by fixing bolts (11). On center part of the said carrier seat (12) is set a countersunk hole where a hollow carrier positioning axis (14) is installed by plugging and fitting. On the said carrier positioning axis (14), a carrier cover plate (13) which engages with the carrier seat (12) is fixed. Between the said carrier positioning axe (14) and the said carrier seat (12), a carrier damping spring (18) is installed. On upper end of the said carrier positioning axis (14), a loading seat (15) which engages with the valve seat (22) by plug and fit is sleeved. On both sides of the said loading seat (15), positioning slots (16) which respectively engage with the side positioning plate (23) and the side valve pipe (19) are installed.

5. A riveting and grinding assembly for nozzle of screw shaft valve in accordance with claim 4, wherein the said valve pipe feeding device (4) may include a loading rack (26) installed on the rack (1), a vibration feeding pan (5), and a carrier support (25) which engages with the carrier assembly (3) and is installed under the turntable (2). On the said feeding rack (26), a transverse feeding plate (34) which is connected to the upper supporting disc (10) is horizontally installed. On the said transverse feeding plate (34), a threaded pipe distribution device which engages with the vibration feeding pan (5) is installed. On upper end of the said feeding rack (26), a feeding cylinder (29) is installed vertically downward. On the output end of the said feeding cylinder (29) is connected a push-in lever (27) which shares the same axis with the carrier positioning axe (14). The lower end of the said push-in lever (27) goes through a push-in guide plate 28 which is installed on the transverse feeding plate (34), and the push-in lever (27) engages with threaded pipe distribution device by means of plug and fit. The said feeding cylinder (29) and the vibration feeding pan 5 are electrically connected to the power control box.

6. A riveting and grinding assembly for nozzle of screw shaft valve in accordance with claim 5, wherein the said threaded pipe distribution device may include a dispensing base (32) which is installed on the transverse feeding plate (34) on horizontal direction. On one end of the said dispensing base (32) is embedded a guiding sliding sleeve (36) which shares the same axis with the push-in lever (27). In the said guiding sliding sleeve (36) is slidably set a push-in joining pipe (37) engaging with the push-in lever (27) by means of plug and fit. On the lower end of the said push-in joining pipe (37), a guiding connecting plate 38 is sleeved. The said guiding connecting plate (38) is connected to the output of joining guide cylinder (33) which is installed on the transverse feeding plate (34) vertically. On the other end of the said distribution seat (32), a pushing cylinder (31) is installed on the horizontal direction. On the output end of the said pushing cylinder (31) is connected a distribution displacement block (35) which slidably engages with the distribution seat (32). On top of the said distribution displacement block (35), a dispensing seat (39) is installed and on the upper end of the said dispensing seat (39) is sleeved a guide tube (30) which engages with the vibration feeding pan (5) by means of plug and fit. The lower end of the said guide tube (30) may communicate with a dispensing hole in the distribution displacement block (35), and lower end of the same dispensing hole may communicate with the push-in joining pipe (37). The said pushing cylinder (31) and joining guide cylinder (33) are electrically connected to the power control box.

7. A riveting and grinding assembly for nozzle of screw shaft valve in accordance with claim 6, wherein the said valve pipe preloading device (6) may include a push-in rack which is installed on the rack (1) and a carrier support (25) which is installed under the turntable (2) and engages with the carrier assembly (3). On the said push-in rack 40, a transverse push-in plate (45) which is connected to the upper supporting disc (10) is installed on horizontal direction. On the transverse push-in plate (45), directly above the carrier assembly a push-in guide bearing (44) is installed by plug and fit. On top of the push-in support (40), a valve pipe push-in cylinder (41) is vertically installed downwards. The output end of the said valve pipe push-in cylinder (41) is connected with a push-in shaft (42), which engages with the push-in guiding bearing (44) by plug and fit, furthermore, the push-in shaft and the thread valve pipe on the carrier assembly (3) shares the same axe. A push-in buffer spring (43) is sleeved to the push-in shaft (42). The said valve pipe push-in cylinder (41) is electrically connected to the power control box.

8. A riveting and grinding assembly for nozzle of screw shaft valve in accordance with claim 7, wherein the said valve pipe riveting device (7) may include a riveting rack (46) which is installed on the rack (1) and a carrier support (25) which is installed under the turntable (2) and engages with the carrier assembly (3). On the said riveting rack (46), a transverse riveting plate (48) which is connected to the upper supporting disc (10) is installed horizontally. Immediately above the carrier assembly (3) on the said transverse riveting plate (48) is set a riveting guide bearing (47) by means of plug and fit. On top of the said riveting rack (46), a riveting cylinder (51) whose output is connected to a riveting spindle (50) is installed vertically downward. On the lower end of the said riveting spindle (50) is set a hole which engages with the threaded pipe (21) by means of plug and fit and inside the hole, there is a guide plug (53) engaging with the threaded pipe (21) by sliding. An inner riveting damper spring 52 is installed at the connection between the upper end of the said guide plug (53) and the riveting spindle (50) while an outer riveting damper spring (49) engaging with the upper end of the riveting guiding bearing (47) is set on the riveting spindle (50). The said riveting cylinder (51) is electrically connected to the power control box.

9. A riveting and grinding assembly for nozzle of screw shaft valve in accordance with claim 1, wherein on the front left of the said turntable (2), an unloading device is installed, which may include an unloading rack (63) which is installed on the rack (1). And on top of the said unloading rack (63), a transverse unloading plate (64) is installed vertically. On the said transverse unloading plate (64), an unloading translational sliding bar (65) is installed vertically. A pneumatic sliding block (66) is slidably fixed on the said unloading translational sliding bar (65). On the said pneumatic sliding block (66), a reclaiming and discharging cylinder (67) is vertically fixed. The output of the said reclaiming and discharging cylinder (67) is connected to a clamping cylinder (68) whose lower end is connected a clamping claw 69 which engages with the screw shaft valve body (17). A clamping opening (70) engaging with the threaded pipe (21) is installed on the said clamping claw (69).
